(19) United States
(12) Patent Application Publication
(10) Pub. No.: US 2016/0375612 A1
(43) Pub. Date: Dec. 29, 2016

(54) METHODS OF PRODUCING PARTITION WALL, DISPLAY ELEMENT AND ELECTROWETTING DISPLAY

(71) Applicant: JSR CORPORATION, Tokyo (JP)

(72) Inventors: Yoshinori KINOSHITA, Tokyo (JP); Daigo ICHINOHE, Tokyo (JP); Kazunari KUDOU, Tokyo (JP)

(73) Assignee: JSR CORPORATION, Tokyo (JP)

(21) Appl. No.: 15/149,308

(22) Filed: May 9, 2016

(30) Foreign Application Priority Data
Jun. 29, 2015 (JP) 2015-129822

(51) Int. Cl. B29C 41/00; B29C 41/50

(52) U.S. Cl. CPC B29C 41/003; B29C 41/50; B29K 2033/04

(57) ABSTRACT

A method of producing a partition wall comprises (a) forming a film using a photosensitive composition, (b) exposing the thus formed film, (c) developing the thus exposed film with an aqueous alkaline solution, and (d) applying wind to the thus developed film. The partition wall compartmentalizes a housing space which is formed between first and second electrode layer stacks and which contains a polar liquid and a non-polar liquid that are immiscible with each other.

### CROSS-REFERENCE TO RELATED APPLICATIONS

The present application claims priority to Japanese Patent Application No. 2015-129822, filed Jun. 29, 2015, under the Paris Convention, the contents of which are incorporated herein by reference in their entirety.

### BACKGROUND OF THE INVENTION

Field of the Invention

The present invention relates to methods of producing a partition wall, a display element and an electrowetting display.

Discussion of the Background

Conventionally, display elements which comprise: a first electrode layer stack; a second electrode layer stack; and a partition wall which compartmentalizes a housing space that is formed between the first and second electrode layer stacks and contains a polar liquid and a non-polar liquid that are immiscible with each other, specifically electrowetting display elements, have been known.

In these electrowetting display elements, the display is switched by a phenomenon which utilizes a change in contact angle of a hydrophobic surface against a polar liquid (and a non-polar liquid) that is induced by, for example, application of a voltage to the polar liquid and non-polar liquid (usually colored) that are immiscible with each other on an electrode having the hydrophobic surface.

Such electrowetting display elements not only show high brightness and high contrast ratio and have large viewing angle, high switching rate and the like, but also are relatively low in power consumption because they do not require front or backlight. Therefore, these elements are used in a variety of optical application fields, including optical switches for optical fibers, optical shutters or filters for cameras and guide devices, optical pickup elements, optical waveguide materials, video display pixels and the like.

For example, JP-A-2013-542465 and JP-A-2013-90701 disclose display elements utilizing such a phenomenon. Further, JP-A-2012-37886 describes, in relation to an electrowetting layer, a method of producing a spacer that compartmentalizes the electrowetting layer.

The above-described electrowetting display elements display letters, figures and the like in response to a change in the state of a non-polar liquid based on the presence or absence of an applied voltage.

### SUMMARY OF THE INVENTION

According to one aspect of the present invention, a method of producing a partition wall comprises the following steps (a) to (d):

(a) forming a film using a photosensitive composition;

(b) exposing the thus formed film;

(c) developing the thus exposed film with an aqueous alkaline solution; and

(d) applying wind to the thus developed film.

The partition wall compartmentalizes a housing space which is formed between first and second electrode layer stacks and which contains a polar liquid and a non-polar liquid that are immiscible with each other:

According to another aspect of the present invention, a method of producing a display element comprises using the partition wall obtained by the method of producing a partition wall.

According to further aspect of the present invention, a method of producing an electrowetting display comprises using the display element obtained by the method of producing a display element.

### BRIEF DESCRIPTION OF DRAWINGS

FIG. 1 is a schematic cross-sectional view showing one example of display element.

FIG. 2 is a schematic plan view showing a partition wall (lattice-patterned coating film) obtained in an Example.

### DESCRIPTION OF THE EMBODIMENTS

The embodiments of the present invention relates to: a method of producing a partition wall, the method comprising specific steps and the partition wall compartmentalizing a housing space which is formed between first and second electrode layer stacks and contains a polar liquid and a non-polar liquid that are immiscible with each other; a method of producing a display element comprising a partition wall obtained by the same; and a method of producing an electrowetting display comprising a display element obtained by the same. Embodiments of the present invention are given below.

[1] A method of producing a partition wall, the method comprising the following steps (a) to (d) and the partition wall compartmentalizing a housing space which is formed between first and second electrode layer stacks and contains a polar liquid and a non-polar liquid that are immiscible with each other:

(a) forming a film using a photosensitive composition;

(b) exposing the thus formed film;

(c) developing the thus exposed film with an aqueous alkaline solution; and

(d) applying wind to the thus developed film.

[2] The method of producing a partition wall according to [1], wherein the step (d) is a wind-blowing step.

[3] The method of producing a partition wall according to [1] or [2], further comprising (e) heating the film after the step (d).

[4] The method of producing a partition wall according to [2] or [3], wherein, in the step (d), the wind-blowing is performed at a wind velocity of 1 to 200 m/sec.

[5] The method of producing a partition wall according to any one of [2] to [4], wherein, in the step (d), the wind-blowing is performed at a wind velocity of 1 to 100 m/sec.

[6] The method of producing a partition wall according to any one of [1] to [5], wherein the aqueous alkaline solution comprises a basic compound.

[7] The method of producing a partition wall according to any one of [1] to [6], wherein the aqueous alkaline solution comprises at least one compound selected from the group consisting of a nitrogen atom-containing compound, a sodium atom-containing compound and a potassium atom-containing compound.

[8] The method of producing a partition wall according to any one of [1] to [7], wherein the aqueous alkaline solution comprises at least one compound selected from the group consisting of tetramethylammonium hydroxide, tetraethylammonium hydroxide, tetrapropylammonium hydroxide, tetrabutylammonium hydroxide, tetrahexylammonium hydroxide, trimethyl(2-hydroxyethyl)ammonium hydroxide, trimethylmonoethanolammonium hydroxide, sodium hydroxide, sodium carbonate, sodium bicarbonate, potassium hydroxide, potassium carbonate and potassium bicarbonate.

[9] The method of producing a partition wall according to any one of [6] to [8], wherein the concentration of the basic compound in the aqueous alkaline solution is 0.01 to 10% by mass.

[10] The method of producing a partition wall according to any one of [6] to [9], wherein the concentration of the basic compound in the aqueous alkaline solution is 0.01 to 5% by mass.

[11] The method of producing a partition wall according to any one of [1] to [10], wherein the aqueous alkaline solution comprises a surfactant.

[12] The method of producing a partition wall according to any one of [1] to [11], wherein the aqueous alkaline solution comprises an organic solvent.

[13] The method of producing a partition wall according to any one of [1] to [12], wherein the photosensitive composition comprises an alkali-soluble polymer and a photoinitiator.

[14] The method of producing a partition wall according to any one of [1] to [13], wherein the photosensitive composition comprises a cross-linking agent.

[15] The method of producing a partition wall according to [13] or [14], wherein the content of the alkali-soluble polymer is 20 to 80% by mass with respect to the total solid content in the photosensitive composition.

[16] The method of producing a partition wall according to any one of [13] to [15], wherein the alkali-soluble polymer is a compound having at least one functional group selected from the group consisting of a carboxyl group, a phenolic hydroxyl group and a silanol group.

[17] The method of producing a partition wall according to any one of [13] to [16], wherein the alkali-soluble polymer is at least one polymer selected from the group consisting of an acrylic resin, a polyimide, a polybenzoxazole, a polysiloxane, a polyolefin, a cardo skeleton-containing resin and a novolac resin.

[18] The method of producing a partition wall according to any one of [14] to [17], wherein the content of the cross-linking agent is 10 to 70% by mass with respect to the total solid content in the photosensitive composition.

[19] The method of producing a partition wall according to any one of [13] to [18], wherein the content of the photoinitiator is 0.1 to 20% by mass with respect to the total solid content in the photosensitive composition.

[20] A display element comprising a partition wall obtained by the method according to any one of [1] to [19].

[21] An electrowetting display comprising the display element according to [20].

[22] The electrowetting display according to [21], comprising a color filter layer.

According to the embodiments of the present invention, a partition wall of a desired shape in which development residues and water specks are reduced can be easily formed, and a display element in which the state of a non-polar liquid can be changed in a smooth and stable manner over a prolonged period of time based on the presence or absence of an applied voltage can be obtained. Particularly, a display element having excellent display properties and reliability can be obtained.

### <<Method of Producing Partition Wall>>

The method of producing a partition wall according to the embodiments of the present invention comprises the following steps (a) to (d), wherein the partition wall is a wall compartmentalizing a housing space which is formed between first and second electrode layer stacks and contains a polar liquid and a non-polar liquid that are immiscible with each other:

(a) the step of forming a film using a photosensitive composition;

(b) the step of exposing the thus formed film;

(c) the step of developing the thus exposed film with an aqueous alkaline solution; and

(d) the step of applying wind to the thus developed film.

By such a method, a partition wall of a desired shape, which has a reduced amount of development residues and water specks and shows excellent resolution as well as excellent patterning properties such as a small amount of in-plane variation, can be easily formed. In a display element comprising such a partition wall, the state of the non-polar liquid can be changed in a smooth and stable manner over a prolonged period of time based on the presence or absence of an applied voltage and, particularly, such a display element has excellent display properties and reliability.

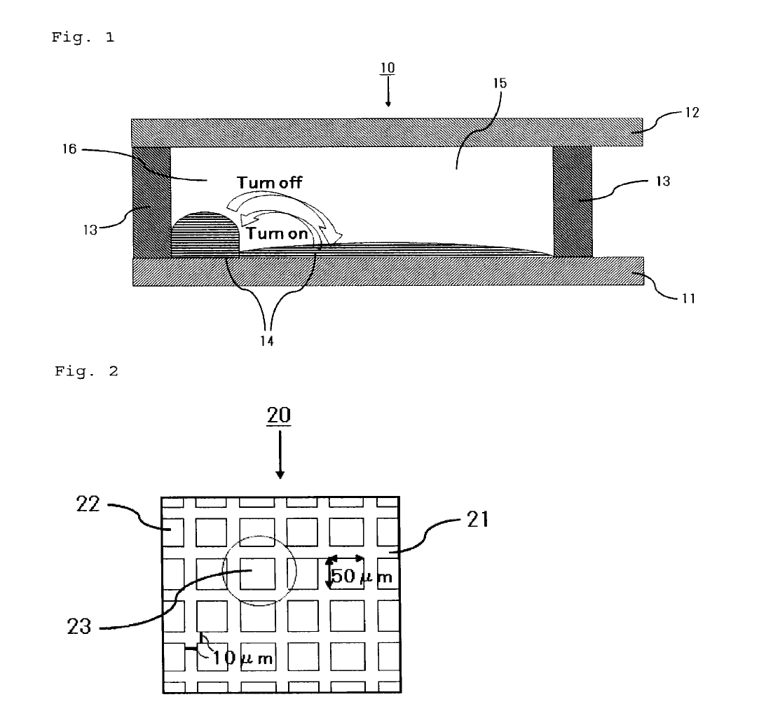

Particularly, a wall compartmentalizing a housing space which is formed between first and second electrode layer stacks and contains a polar liquid and a non-polar liquid that are immiscible with each other is usually required to have a certain height (length in the direction corresponding to the vertical direction in FIG. 1). Since those films used in ordinary display devices have a height (film thickness) of 2 to 3 μm, the partition wall is required to have a certain thickness (thick film) in comparison to such films. The present inventor found that, when a thick film is formed by a conventional method to prepare a display element, the display element is not capable of performing desired display and its display reliability is impaired. As a result of intensively studying these problems, it was discovered that water droplets containing development residues and the like cause adhesion of development residues and formation of water specks on the display part of a display element, making the display element unable to perform desired display and impairing the display reliability; and that, according to the above-described method of producing a partition wall that comprises the steps (a) to (d), these problems can be solved and the above-described effects are exerted.

The term “water specks” used in the embodiments of the present invention refers to water marks that are left at spots where water existed, such as water deposits.

<Step (a)>

The step (a) is a step of forming a film using a photosensitive composition. The film formed by this step (a) yields a partition wall through the subsequent steps (b) to (d) and the like.

Examples of the step (a) include, but not particularly limited to, a step of forming a film by, for example, coating a photosensitive composition on the first or second electrode layer stack or a support other than the first and second electrode layer stacks (hereinafter, also simply referred to as “other support”) and then, as required, prebaking the thus coated photosensitive composition.

The method of coating a photosensitive composition is not particularly restricted and a conventionally known method can be employed, and examples thereof include a dipping method, a spray method, a bar coating method, a roll coating method, a spin coating method, a curtain coating method, a gravure printing method, a silk-screen method and an ink-jet method.

Further, when coating a photosensitive composition, it is desired that the photosensitive composition be coated such that the partition wall eventually obtained has a thickness (length in the direction corresponding to the vertical direction in FIG. 1) of preferably 5 to 40 μm.

Examples of the above-described other support include substrates made of a resin such as polyethylene terephthalate, glass substrates, quartz substrates, ceramic substrates, substrates made of a metal such as aluminum or SUS, and wafers.

In cases where such other support is used, after the step (a), (c), (d) or the like, the resulting film may be detached from the support and then arranged on the first or second electrode layer stack using a conventionally known adhesive or the like.

In this manner, in cases where the above-described other support is used, for example, it is required to perform the steps of detaching the resulting film from the support and arranging the film on the first or second electrode layer stack; therefore, in the step (a), it is preferred that the photosensitive composition be coated and the like on the first or second electrode layer stack.

The conditions of the prebaking are not particularly restricted; however, the prebaking is preferably performed under such conditions that allow removal of a solvent(s) and the like from the coated photosensitive composition.

Specifically, the prebaking is performed using an oven or a hot plate, for example, at a heating temperature of preferably 80 to 150° C., more preferably 90 to 140° C., for a period of preferably 60 to 600 seconds, more preferably 100 to 420 seconds.

By performing the prebaking under these conditions, a partition wall of a desired shape, which has excellent resolution as well as excellent patterning properties such as a small amount of in-plane variation, can be easily formed.

Further, as required, the prebaking may also be performed in an inert gas atmosphere such as nitrogen gas or under reduced pressure.

### [Photosensitive Composition]

The above-described partition wall is formed using a photosensitive composition. By using a photosensitive composition, a display element comprising plural pixel regions that are formed by compartmentalizing a housing space with plural partition walls can be easily produced.

The photosensitive composition may be a positive photosensitive composition or a negative photosensitive composition; however, it is preferably a negative photosensitive composition because, for example, it enables to easily produce a display element comprising plural pixel regions that are formed by compartmentalizing a housing space with plural partition walls and a display element in which deterioration of the display properties is not likely to occur over a prolonged period can thus be obtained.

The photosensitive composition is not particularly restricted; however, it is preferably a composition containing an alkali-soluble polymer and a photoinitiator because, for example, such a composition can yield a partition wall that shows only small changes in the properties over a prolonged period, and it is preferred that the composition further contain a cross-linking agent. Examples of such a composition include those described in JP-A-2006-154434 and JP-A-2007-293306.

### <Alkali-Soluble Polymer>

The alkali-soluble polymer is not particularly restricted. In the embodiments of the present invention, the term “alkali-soluble” means that the polymer can be dissolved or swollen in an aqueous alkaline solution such as 2.38%-by-mass aqueous tetramethylammonium hydroxide solution.

As the alkali-soluble polymer, a single alkali-soluble polymer may be used individually, or two or more alkali-soluble polymers, for example, a blend of two or more alkali-soluble polymers may be used. Further, a blend of one or more alkali-soluble polymers and an alkali-insoluble polymer or the like may also be used.

From the standpoints of, for example, the solubility in aqueous alkaline solutions, particularly in 2.38%-by-mass aqueous tetramethylammonium hydroxide solution, the alkali-soluble polymer is preferably a compound having at least one functional group selected from the group consisting of a carboxyl group, a phenolic hydroxyl group and a silanol group (such a functional group is hereinafter also referred to as “soluble group”).

As such an alkali-soluble polymer, an acrylic resin, a polyimide, a polybenzoxazole, a polysiloxane, a polyolefin, a cardo skeleton-containing resin and a novolac resin are preferred and, from the standpoint of the alkali solubility, these resins having the above-described soluble group(s) are preferred.

From the standpoints of the developability and the like of the resulting photosensitive composition, the weight-average molecular weight of the alkali-soluble polymer, which is measured by gel permeation column chromatography (GPC), specifically the method described in the section of Examples below, is preferably 1,000 to 100,000, more preferably 1,500 to 50,000.

From the standpoints of the developability and the like of the resulting photosensitive composition, the content of the alkali-soluble polymer is preferably 20 to 80% by mass, more preferably 30 to 75% by mass, still more preferably 35 to 65% by mass, with respect to 100% by mass of the total solid content in the photosensitive composition.

It is noted here that, in the embodiments of the present invention, the term “solid content” in a composition refers to a component (s) contained in the composition other than a solvent (s).

Acrylic Resin

The acrylic resin is not particularly restricted; however, from the standpoints of the developability and the like of the resulting photosensitive composition, it is preferably a copolymer obtained using the below-described compounds (a) and (b) as monomers (it is noted here that the monomers include acrylic compounds):

compound (a): a compound having at least one functional group selected from the group consisting of a carboxyl group, a phenolic hydroxyl group and a silanol group; and

compound (b): a compound other than the compound (a).

Examples of the compound (a) include monocarboxylic acids such as (meth)acrylic acid; maleic acid; methacrylic acid derivatives having an ester bond; phenolic hydroxyl group-containing vinyl monomers such as isopropenylphenol; and hydrolysates of alkoxysilyl group-containing vinyl monomers such as vinyltrimethoxysilane, among which (meth)acrylic acid and 4-isopropenylphenol are preferred.

The compound (a) may be used individually, or two or more thereof may be used.

Examples of the compound (b) include alkyl (meth)acrylates; hydroxyl group-containing (meth)acrylates; halogen atom-containing (meth)acrylates; aryl (meth)acrylates; heterocyclic group-containing (meth)acrylates; dicarboxylic acid diesters; vinyl group-containing aromatic compounds such as methylstyrene; nitrile group-containing polymerizable compounds; chlorine-containing polymerizable compounds such as vinyl chloride; amide bond-containing polymerizable compounds such as (meth)acrylamide; imide group-containing polymerizable compounds such as N-phenylmaleimide; and vinyl fatty acids such as vinyl acetate.

Thereamong, (meth)acrylates such as methyl methacrylate, n-butyl (meth)acrylate, 2-methoxyethyl acrylate, benzyl methacrylate and 2-hydroxyethyl methacrylate; styrene; and N-phenylmaleimide are preferred.

The compound (b) may be used individually, or two or more thereof may be used.

The compound (b) is used in an amount of preferably 5 to 95% by mass, more preferably 10 to 90% by mass, with respect to a total of 100% by mass of the compounds (a) and (b).

Polyimide

The polyimide is not particularly restricted; however, from the standpoint of the alkali solubility, it is preferably a polymer having the above-described soluble group(s) and a structural unit represented by the following Formula (A1).

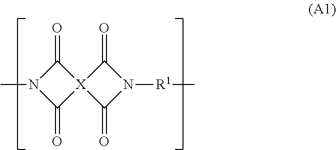

In the Formula (A1), R¹ represents a hydroxyl group-containing divalent group and X represents a tetravalent organic group. Examples of the R¹ include divalent groups represented by the following Formula (al).

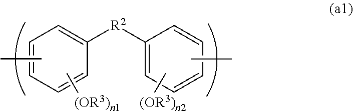

In the Formula (al), R² represents a single bond, O, S, —SO₂—, —CO—, —CH₂—, —C(CH₃)₂— or a —C(CF₃)₂— group; and R³s independently represent H, —C(═O)H, an acyl group or an alkyl group. However, at least one of the R³s is H. Further, n1 and n2 each independently represent an integer of 0 to 2, with a proviso that at least one of n1 and n2 is 1 or 2. When the sum of n1 and n2 is 2 or larger, the plural R³s may be the same or different.

Examples of the tetravalent organic group represented by the X include tetravalent aliphatic hydrocarbon groups, tetravalent aromatic hydrocarbon groups and groups represented by the following Formula (1), and the X is more preferably a group represented by the following Formula (1).

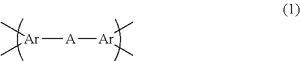

In the Formula (1), Ars independently represent a trivalent aromatic hydrocarbon group, and A represents a direct bond or a divalent group. Examples of the divalent group include —O—, —S—, —SO₂—, —CO—, —CH₂—, —C(CH₃)₂— and —C(CF₃)₂—.

Polybenzoxazole

The polybenzoxazole is not particularly restricted; however, from the standpoint of the alkali solubility, it is preferably a polymer having the above-described soluble group(s) and a structural unit represented by the following Formula (a5-1).

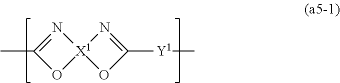

In the Formula (a5-1), X¹ represents an aromatic ring-containing tetravalent organic group, and Y¹ represents a divalent organic group.

In the Formula (a5-1), the aromatic ring of the X¹ may be either a substituted or unsubstituted ring. Examples of a substituent include —OH, —COOH, alkyl groups, alkoxy groups and alicyclic hydrocarbon groups. The N and O binding to the X¹ are, for example, bound to adjacent carbon atoms on the aromatic ring of the X¹, forming a benzoxazole ring.

The total number of carbon atoms in the X¹ is preferably 6 to 24.

In the Formula (a5-1), Y¹ is preferably a divalent group containing at least one ring selected from alicyclic rings and aromatic rings.

The alicyclic ring(s) and/or aromatic ring(s) contained in the Y¹ may each be a substituted or unsubstituted ring. Examples of a substituent include —OH, —COOH, alkyl groups, alkoxy groups, alkoxycarbonyl groups and alicyclic hydrocarbon groups.

The total number of carbon atoms in the Y¹ is preferably 4 to 24.

Polysiloxane

The polysiloxane is not particularly restricted; however, from the standpoint of the alkali solubility, it is preferably a polysiloxane which has the above-described soluble group(s) and is obtained by hydrolysis and partial condensation of an organosilane represented by the following Formula (a4).

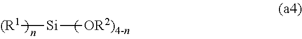

In the Formula (a4), R¹ represents a hydrogen atom, an alkyl group having 1 to 10 carbon atoms, an alkenyl group having 2 to 10 carbon atoms, an aryl group-containing group having 6 to 15 carbon atoms, an epoxy ring-containing group having 2 to 15 carbon atoms or a group obtained by replacing one or more hydrogen atoms contained in the above-described alkyl group with a substituent (substituted alkyl group) and, when there are plural R¹s, the R¹s may be the same or different from each other; R² represents a hydrogen atom, an alkyl group having 1 to 6 carbon atoms or an aryl group having 6 to 15 carbon atoms and, when there are plural R²s, the R²s may be the same or different from each other; and n represents an integer of 0 to 3.

The above-described substituent is, for example, at least one selected from halogen atoms, an amino group, a hydroxyl group, a mercapto group and a (meth)acryloyloxy group.

Polyolefin

The polyolefin is not particularly restricted; however, from the standpoint of the alkali solubility, it is preferably a cyclic olefin polymer having a protic polar group. The term “protic polar group” refers to a group in which a hydrogen atom is directly bound to an atom belonging to the Group 15 or 16 of the periodic table, preferably an oxygen atom, a nitrogen atom or a sulfur atom, particularly preferably an oxygen atom.

Specific examples of the polyolefin include those polymers described in JP-A-2012-211988.

Cardo Skeleton-Containing Resin

The cardo skeleton-containing resin is not particularly restricted. The “cardo skeleton” refers to a skeletal structure in which two cyclic structures are bound to a ring carbon atom constituting a cyclic structure, and examples thereof include a structure in which two aromatic rings (e.g., benzene rings) are bound to the carbon atom at the 9-position of a fluorene ring.

Specific examples of the cardo skeleton-containing resin include those polymers described in Japanese Patent No. 5181725 and Japanese Patent No. 5327345.

Novolac Resin

The novolac resin is not particularly restricted. Examples of the novolac resin include resins having, for example, a phenol novolac structure or a resol novolac structure, which are obtained by reaction between a phenol compound and an aldehyde compound.

Specific examples of the novolac resin include those polymers described in JP-A-2003-114531, JP-A-2012-137741 and JP-A-2013-127518.

### <Photoinitiator>

The photoinitiator is not particularly restricted as long as it is a compound which is capable of initiating polymerization when irradiated with light such as radiation, and a conventionally known compound can be used as the photoinitiator.

Examples of such a compound include 1-[9-ethyl-6-(2-methylbenzoyl)-9H-carbazol-3-yl]ethanone 1-(O-acetyloxime), 2,4,6-trimethylbenzoyl-diphenyl-phosphine oxide and bis(2,4,6-trimethylbenzoyl)-phenylphosphine oxide.

The above-described photoinitiator may be used individually, or two or more thereof may be used.

From the standpoints of, for example, obtaining a composition having excellent photosensitivity, the content of the photoinitiator (s) is preferably 0.1 to 20% by mass, more preferably 0.5 to 10% by mass, with respect to 100% by mass of the total solid content in the photosensitive composition. By controlling the content of the photoinitiator(s) in this range, the developability of the partition wall formed from the photosensitive composition tends to be improved without impairing the sensitivity.

### <Cross-Linking Agent>

The cross-linking agent is not particularly restricted as long as it has a cross-linkable functional group.

From the standpoints of, for example, obtaining a partition wall that has excellent surface hardness and shows only small changes in the properties over a prolonged period, the cross-linkable functional group is preferably an ethylenically unsaturated group such as a (meth)acryloyl group, an epoxy group, an oxetanyl group or an alkoxyalkyl group.

The above-described cross-linking agent may be used individually, or two or more thereof may be used.

From the standpoints of, for example, obtaining a composition having excellent photosensitivity and a partition wall showing only small changes in the properties over a prolonged period, the content of the cross-linking agent (s) is preferably 10 to 75% by mass, more preferably 20 to 65% by mass, particularly preferably 25 to 55% by mass, with respect to 100% by mass of the total solid content in the photosensitive composition.

### <Other Components>

In the photosensitive composition, other components, for example, other additives such as an organic solvent, an antioxidant, a thermal polymerization inhibitor, a surfactant, an adhesive assistant, a solubility modifier, a viscosity modifier, a filler (e.g., an inorganic filler) and a colorant can be further incorporated within a range that does not adversely affect the effects of the embodiments of the present invention.

Examples of the organic solvent include those described in JP-A-2006-201670, JP-A-2012-256023, JP-A-2014-013413 and the like.

Examples of the antioxidant include those described in JP-A-2010-117614, JP-A-2010-184961, JP-A-2013-241554 and the like.

Examples of the surfactant include those described in JP-A-2010-250109, JP-A-2014-089970, JP-A-2014-048428 and the like.

Examples of the adhesive assistant include those described in JP-A-2012-256023, JP-A-2013-242511, JP-A-2014-080578 and the like.

Examples of the inorganic filler include those described in JP-A-2007-332255, JP-A-2012-198527, JP-A-2014-062195 and the like.

Examples of other additives include those compounds that are described in JP-A-2006-154434, JP-A-2007-293306 and the like.

### <Method of Preparing Photosensitive Composition>

The photosensitive composition can be prepared by, for example, mixing an alkali-soluble polymer, a cross-linking agent, a photoinitiator and, as required, the above-described other component(s).

<Step (b)>

The step (b) is the step of exposing the film formed in the step (a).

The step (b) is not particularly restricted and, specifically, by irradiating (exposing) the film formed in the step (a) with light through a mask having a prescribed pattern, a partition wall of a desired shape such as a lattice shape can be obtained, and this enables to easily produce a display element comprising plural pixel regions that are formed by compartmentalizing the housing space with plural partition walls.

For the exposure, for example, a stepper such as an aligner or a scanner can be used. Examples of an exposure light include UV radiation and visible light, and a light having a wavelength of 200 to 500 nm (e.g., i-line (365 nm)) is normally used.

The exposure dose in the exposure of the step (b) varies depending on the types and the blending ratios of the respective components in the photosensitive composition, the thickness of the coating film and the like; however, when i-line is used as the exposure light, the exposure dose is preferably 30 to 1,200 mJ/cm², more preferably 50 to 750 mJ/cm².

By exposing the film formed in the step (a) at the above-described exposure dose, a partition wall of a desired shape, which has excellent resolution as well as excellent patterning properties such as a small amount of in-plane variation, can be easily formed.

Further, as long as the effects of the embodiments of the present invention are not adversely affected, a heat treatment may also be performed after the step (b) but before the below-described step (c).

<Step (c)>

The step (c) is the step of developing the thus exposed film with an aqueous alkaline solution. In the step (c), specifically, the film obtained in the step (b) is developed with an aqueous alkaline solution and the exposed parts (in the case of positive type) or non-exposed parts (in the case of negative type) are dissolved and removed, thereby a desired pattern is formed.

Examples of a developing method include shower development, spray development, immersion development, paddle development, brush development and ultrasonic development.

As for the development conditions, for example, the temperature is preferably 20 to 30° C., more preferably 22 to 25° C., and the film obtained in the step (b) and the aqueous alkaline solution are brought into contact for a period of preferably 30 to 360 seconds, more preferably 30 to 240 seconds.

By performing the development under the above-described conditions, a partition wall of a desired shape, which has excellent resolution as well as excellent patterning properties such as a small amount of in-plane variation, can be easily formed.

It is preferred that the aqueous alkaline solution contain a basic compound. In the embodiments of the present invention, the term “basic compound” refers to a compound that shows alkalinity in an aqueous solution.

As the basic compound, from the standpoints of the developing properties and the like, it is preferred that at least one compound selected from the group consisting of nitrogen atom-containing compounds, sodium atom-containing compounds and potassium atom-containing compounds be incorporated.

As the basic compound, it is preferred that at least one compound selected from the group consisting of tetramethylammonium hydroxide, tetraethylammonium hydroxide, tetrapropylammonium hydroxide, tetrabutylammonium hydroxide, tetrahexylammonium hydroxide, trimethyl(2-hydroxyethyl)ammonium hydroxide, trimethylmonoethanolammonium hydroxide, sodium hydroxide, sodium carbonate, sodium bicarbonate, potassium hydroxide, potassium carbonate and potassium bicarbonate be further incorporated.

As the basic compound, it is more preferred that at least one compound selected from the group consisting of tetramethylammonium hydroxide, tetraethylammonium hydroxide, tetrapropylammonium hydroxide, tetrabutylammonium hydroxide, tetrahexylammonium hydroxide, trimethyl(2-hydroxyethyl)ammonium hydroxide and trimethylmonoethanolammonium hydroxide be further incorporated.

By using the above-described compound(s) as the basic compound, a partition wall of a desired shape, which has excellent resolution as well as excellent patterning properties such as a small amount of in-plane variation, can be easily formed.

In the aqueous alkaline solution, the concentration of the basic compound is preferably 0.01 to 10% by mass, more preferably 0.01 to 5% by mass, still more preferably 0.01 to 4% by mass.

When the concentration of the basic compound in the aqueous alkaline solution is in this range, the first and second electrode layer stacks are not damaged, and a partition wall of a desired shape, which has excellent developability and resolution as well as excellent patterning properties such as a small amount of in-plane variation, can be easily formed.

In the aqueous alkaline solution, in addition to the basic compound, for example, a surfactant, an organic solvent, a pH modifier such as citric acid, a chelating agent for divalent metals such as magnesium and calcium and an antifoaming agent may also be incorporated within a range that does not adversely affect the effects of the embodiments of the present invention.

Examples of the organic solvent include ethyl alcohol, isopropyl alcohol, benzyl alcohol, ethyl cellosolve, butyl cellosolve, phenyl cellosolve, propylene glycol and diacetone alcohol. Further, for example, those organic solvents described in WO2014/002835 can also be used.

These organic solvents may be used individually, or two or more thereof may be used.

Examples of the surfactant include nonionic surfactants such as polyoxyethylene alkyl ethers, polyoxyethylene alkylaryl ethers, polyoxyethylene alkyl esters, sorbitan alkyl esters and monoglyceride alkyl esters; anionic surfactants such as alkylbenzene sulfonates, alkylnaphthalene sulfonates, alkyl sulfates, alkyl sulfonates and sulfosuccinic acid ester salts; and amphoteric surfactants such as alkyl betaines and amino acids. Further, for example, those surfactants described in WO2014/002835 can also be used.

These surfactants may be used individually, or two or more thereof may be used.

After the step (c), for the purpose of removing the basic compound and the like contained in the aqueous alkaline solution, it is preferred that the developed film be washed with water or the like.

<Step (d)>

The step (d) is the step of applying wind to the thus developed film.

Conventionally, developed films are heated without such a step of applying wind thereto. Since the moisture and the like contained in the developed films can be removed by the heating, such a step of purposely applying wind or the like has not been implemented. However, as a result of intensive studies for objects of, for example, forming a partition wall of a desired shape, which has excellent resolution as well as excellent patterning properties such as a small amount of in-plane variation, and obtaining a display element having excellent display properties, the present inventor discovered that these objects can be achieved by applying wind to the developed film. Consequently, the present inventor also discovered that this enables to obtain a display element that has excellent display properties and reliability. The point that such a display element can be obtained by simple application of wind to the developed film is a prominent effect that cannot be anticipated by those of ordinary skill in the art.

The step (d) is preferably a step by which moisture and development residues, namely residues of the components contained in the aqueous alkaline solution such as basic compound residue, can be removed from the developed film. Accordingly, from the standpoint of obtaining a partition wall with reduced development residues and water specks, the step (d) is preferably a wind-blowing step.

Specific examples of a method of applying wind to the developed film include: wind-blowing methods such as air-blowing, air-knifing and ultrasonic air; and spinning methods in which wind is applied to a developed film by generating the wind with rotation of the developed film or the like. Further, such a wind-blowing method and a spinning method may also be performed simultaneously.

For example, as a means for applying wind by air blowing, any method that provides wind over the surface of the developed film, such as a method of ejecting compressed air from a nozzle or a method of blowing wind using a propeller-shaped fan, can be used.

Examples of the “wind” to be applied to the film usually include atmosphere (air); however, depending on the application of the resulting partition wall, the wind may also be of a gas such as nitrogen. That is, the above-described “air” may also be atmosphere or a gas such as nitrogen.

The step (d) may be performed only on the developed film; however, in cases where a partition wall is directly formed on the first or second electrode layer stack, the step (d) is preferably a step of applying wind against the resulting laminate that contains the electrode layer stacks and the developed film. It is particularly preferred that the step (d) is a step of removing development residues and moisture from the developed film as well as the electrode layer stacks constituting a display part. When the step (d) is such a step, a display element which is capable of performing more desirable display and has superior display reliability can be obtained.

Considering the capability of removing the development residues, water specks and the like, it is preferred that the wind-blowing velocity be high; however, since the film may be damaged when wind is blown thereto at an excessively high wind velocity, it is preferred to set moderate conditions.

The wind velocity at which wind is blown (the speed of blown wind) is preferably 1 to 200 m/sec, more preferably 1 to 100 m/sec, still more preferably 5 to 100 m/sec.

Further, although the duration of the wind application is variable depending on the wind velocity at which wind is blown, it is, for example, preferably 3 to 180 seconds, more preferably 5 to 120 seconds.

When wind is applied, the wind usually has room temperature; however, as required, a warm wind of 22 to 45° C. or so may be applied as well.

<Step (e)>

In the method of producing a partition wall according to the embodiments of the present invention, after the step (d), for the purpose of sufficiently curing the film obtained in the step (d) so as to allow the film to adequately express its properties as a partition wall, the step (e) of heating (drying) the film obtained in the step (d) may also be performed as required.

The heating conditions are not particularly restricted; however, for example, the heating temperature is preferably 150 to 300° C., more preferably 180 to 250° C., still more preferably 200 to 250° C., and the heating time is preferably 20 to 180 minutes, more preferably 30 to 120 minutes.

By performing the heating under the above-described conditions, a partition wall of a desired shape, which has excellent resolution as well as excellent patterning properties such as a small amount of in-plane variation, can be easily formed.

In order to allow the curing of the film obtained in the step (d) to sufficiently progress and to inhibit deformation of the pattern shape, the heating can also be performed in two or more steps. For example, the film may be heated at a temperature of 60 to 150° C. for about 5 to 60 minutes in the first step and then at a temperature of higher than 200° C. but not higher than 250° C. for about 5 to 60 minutes in the second step.

The step (e) can be performed by, for example, using an ordinary oven or the like as a heating equipment.

Further, as required, the step (e) may be performed in an inert gas atmosphere such as nitrogen gas or under reduced pressure.

<Step (f)>

In the method of producing a partition wall according to the embodiments of the present invention, after the above-described step (d) or (e), the step (f) of treating the surface(s) of the film obtained in the step (d) or (e) may also be performed for the purpose of, for example, imparting the resulting partition wall with desired properties.

The step (f) is not particularly restricted and may be, for example, the step of subjecting a surface, preferably both surfaces of the film obtained in the step (d) or (e) to hydrophilization by a conventionally known hydrophilization method or hydrophobization by a hydrophobization method.

Examples of the hydrophilization method include a method of modifying the film surface by a corona discharge treatment, a plasma treatment or an UV-ozone treatment; and a method of layering a film made of an acrylic resin, a sulfonate group-containing resin or the like on the film surface by coating or lamination.

Examples of the hydrophobization method include a method of modifying the film surface by a surface treatment with a long-chain alkyl group-containing coupling agent, a fluorine-containing coupling agent or a silicon-containing coupling agent; and a method of layering a film made of a long-chain alkyl group-containing resin, a fluorine-containing resin, a silicon-containing resin or the like on the film surface by coating or lamination.

For example, in cases where a film is formed from the photosensitive composition and the surface of the film is subjected to an UV-ozone treatment, the exposure dose in this treatment is preferably 0.1 to 8 J/cm²@254 nm, more preferably 0.5 to 5 J/cm^{2@254} nm, because this enables to, for example, impart the resulting partition wall with desired properties and thereby obtain a partition wall having, for example, the below-described Martens hardness.

### <<Partition Wall>>

The partition wall obtained by the method of producing a partition wall according to the embodiments of the present invention compartmentalizes the housing space formed between the first and second electrode layer stacks. The partition wall is not particularly restricted as long as it functions as a wall that prevents the movement of the non-polar liquid between adjacent pixel regions (cells) that usually exist in series.

Accordingly, the partition wall may be in contact with both a first electrode layer stack 11 and a second electrode layer stack 12 as shown in FIG. 1; however, when a non-polar liquid 14 exists on the side of the first electrode layer stack 11 in a housing space 16 as shown in FIG. 1, the partition wall may exist only on the side of the first electrode layer stack 11 and does not have to be in contact with the second electrode layer stack 12. In the latter case, the partition wall may be in contact with the first electrode layer stack 11, or a small gap may exist between the partition wall and the first electrode layer stack 11.

When the partition wall is in contact with the first electrode layer stack and/or the second electrode layer stack, the partition wall may be integrated with the first electrode layer stack and/or the second electrode layer stack, or the partition wall may be adhered to the first electrode layer stack and/or the second electrode layer stack.

The partition wall has a Martens hardness, which is measured using a micro hardness tester, of preferably not less than 110 N/mm², more preferably not less than 130 N/mm², particularly preferably 140 to 300 N/mm².

Specifically, the Martens hardness can be measured using a micro hardness tester (FISHERSCOPE HM2000, manufactured by Fisher Instruments K.K.).

When the Martens hardness of the partition wall is in the above-described range, movement of the non-polar liquid between pixel regions can be sufficiently inhibited and a display element having excellent durability can be obtained.

A partition wall having such a Martens hardness can be obtained by adjusting the type and amount of the above-described cross-linking agent as appropriate or by adjusting the hardness of a surface-coating film applied in the above-described surface treatment step.

The height of the partition wall (length in the direction of the gap between the first and second electrode layer stacks; length in the vertical direction in FIG. 1) is not particularly restricted as long as the partition wall can function to inhibit the movement of the non-polar liquid between pixel regions; however, it is preferably 5 to 40 μm, more preferably 10 to 30 μm.

Further, the thickness of the partition wall (length in the direction substantially perpendicular to the direction of the gap between the first and second electrode layer stacks; length in the horizontal direction in FIG. 1) is also not particularly restricted as long as the partition wall can function to inhibit the movement of the non-polar liquid between pixel regions; however, from the standpoints of the strength and the like of the partition wall, the thickness of the partition wall is 1 to 50 μm, preferably 5 to 40 μm.

The partition wall may be a single-layer film, or a laminate comprising a BM (black matrix) layer, a reinforcement layer, a surface-coating layer or the like. Further, the partition wall may be a film having no hole, or a film having lattice-form or slit-form holes.

<<Display Element>>

According to the embodiments of the present invention, for example, a display element shown in FIG. 1, which comprises: a first electrode layer stack 11; a second electrode layer stack 12; a housing space 16 formed between the first electrode layer stack 11 and the second electrode layer stack 12; and a partition wall 13 that compartmentalizes the housing space 16, particularly a display element having excellent display properties and reliability, can be easily produced.

Usually, the housing space 16 comprises at least a polar liquid 15 and a non-polar liquid 14 that are immiscible with each other.

In FIG. 1, the surface of the first electrode layer stack 11 that is in contact with the housing space (pixel region (cell)) 16 is hydrophobic. Thus, in a display element 10, when no voltage is applied (“turn off” in FIG. 1), the non-polar liquid (colored liquid) 14 exists evenly such that it covers the surface of the first electrode layer stack 11. Meanwhile, when voltage is applied to this display element 10 (“turn on” in FIG. 1), the non-polar liquid 14 exists in a substantially hemispherical shape near the partition wall 13.

In this manner, in the above-described display element, the state of the non-polar liquid changes based on the presence or absence of an applied voltage and, by using a colored non-polar liquid, the display element is allowed to display, for example, a colored state and a transparent state.

The voltage to be applied is not particularly restricted as long as it is such a voltage that can change the state of the non-polar liquid.

The display element may be an element that comprises a single pixel region (cell) formed by compartmentalizing the housing space with four partition walls or the like; however, it is usually an element comprising plural pixel regions that are formed by compartmentalizing the housing space with plural partition walls. Each pixel region is formed such that it is capable of performing full-color display on the display surface side of the display element. Further, by allowing the state of the non-polar liquid in each pixel region to be changed by an electrowetting phenomenon, the colors displayed on the display surface side can be modified.

### <First Electrode Layer Stack and Second Electrode Layer Stack>

The first and second electrode layer stacks are not particularly restricted; however, they are each preferably a stack (laminate) made of a transparent material.

The first and second electrode layer stacks usually comprise: a transparent substrate made of glass or resin; and a transparent electroconductive layer made of a transparent electroconductive material such as indium tin oxide (ITO).

When such electrode layer stacks are used, they are arranged such that their transparent electroconductive layer sides face with each other.

The first and second electrode layer stacks may further comprise other layer(s), for example, a conventionally known layer(s) such as a planarization film, a passivation film, a reflective film, an insulation film and/or a hydrophobic film, on the transparent substrate or transparent electroconductive layer or therebetween.

The surface of at least one of the first and second electrode layer stacks that is in contact with the housing space is hydrophobic. The two surfaces of the first and second electrode layer stacks that are in contact with the housing space may both be hydrophobic; however, in that case, these surfaces may have different levels of hydrophobicity, with the hydrophobicity of one of the surfaces being higher than that of the other surface.

In other words, in the display element, the first and second electrode layer stacks may have such hydrophobic surfaces that, when no voltage is applied between the first and second electrode layer stacks, allow the non-polar liquid to exist on the surface of one of the first and second electrode layer stacks that is in contact with the housing space.

An electrode layer stack having a hydrophobic surface can be obtained by, for example, coating a hydrophobic material-containing composition to form a coating film or laminating a film made of a hydrophobic material on the surface of the above-described laminate comprising a transparent substrate and a transparent electroconductive layer.

Examples of the hydrophobic material include fluorine-containing materials and silicon-containing materials, and specific examples thereof include those described in JP-A-H04-290746, JP-A-2010-054785, JP-A-H09-208265 and JP-A-2012-181513, among which the materials described in JP-A-2010-054785 and JP-A-H09-208265 are preferred.

### <Housing Space>

The housing space may be a space of any size as long as it can contain a polar liquid and a non-polar liquid and does not interfere with the change in the state of the non-polar liquid based on the presence or absence of an applied voltage. The housing space can be selected as appropriate in accordance with the desired application as well as the size of the pixel regions desired to be displayed and the like.

### <Polar Liquid>

The polar liquid is stored in the housing space. The polar liquid is not particularly restricted as long as it is immiscible with the non-polar liquid to be used; however, it is preferably an electroconductive liquid that is colorless and transparent. Specifically, as the polar liquid, in addition to water, an aqueous solution or the like in which an electrolyte such as lithium chloride, potassium chloride or sodium chloride is dissolved can be used.

As the polar liquid, two or more kinds of liquid may be used; however, a single kind of liquid is usually used.

### <Non-Polar Liquid>

The non-polar liquid is also stored in the housing space. The non-polar liquid is not particularly restricted; however, it is preferably a liquid that is hardly polar and shows electrical insulation.

Examples of the non-polar liquid include hydrophobic liquids such as side-chain higher alcohols, side-chain higher fatty acids, alkane hydrocarbons such as octane and decane, and silicone oil.

As the non-polar liquid, two or more kinds of liquid may be used; however, a single kind of liquid is usually used.

The amount of the non-polar liquid to be stored in each pixel region (cell) can be adjusted as appropriate in accordance with the desired application; however, it is preferably, for example, such an amount that can cover the entire surface of the electrode layer stack on the display surface side of the display element.

The non-polar liquid is preferably a liquid having a color (colored liquid), particularly preferably the above-described hydrophobic liquid in which a color material that can be dissolved or uniformly dispersed therein, such as a dye or a pigment, is blended. The colored liquid may be transparent or opaque.

Examples of the dye include those described in JP-A-2014-010249 and JP-A-2013-228683, and examples of the pigment include carbon blacks and pigments described in JP-A-2012-181513.

As the color material, one which allows the non-polar liquid to absorb light having a prescribed wavelength can be selected as appropriate in accordance with the desired application, and such a color material may be used individually, or two or more thereof may be used.

When the non-polar liquid contains a color material, the content thereof is not particularly restricted and can be adjusted as appropriate in accordance with the desired application; however, it is preferred that the color material be contained in such an amount that it can be dissolved or uniformly dispersed in the hydrophobic liquid, for example, 0.01 to 30% by mass with respect to 100% by mass of the non-polar liquid.

Even when the non-polar liquid contains a color material in such an amount, the presence of the color material does not cause a change in the static contact angle of the non-polar liquid on the partition wall surface.

Further, as required, the non-polar liquid may also contain a variety of additives, such as an ultraviolet absorber and an antioxidant, within a range that does not adversely affect the effects of the embodiments of the present invention.

### <<Electrowetting Display>>

According to the embodiments of the present invention, an electrowetting display comprising the above-described display element, particularly an electrowetting display having a long service life and excellent display properties, can be easily produced.

The electrowetting display can be produced by laminating conventionally known layers that have been used in conventional electrowetting displays, such as an insulation film, a thin-film transistor (TFT), a color filter layer and a black matrix, at the desired place in the desired order in accordance with the desired application. Such a constitution of the electrowetting display may be the same as, for example, the one described in JP-A-2013-142753 or JP-A-2012-63767, except that the above-described display element is used.

Particularly, it is preferred that the electrowetting display contain a color filter layer because this enables to, for example, produce a display capable of performing full-color display on the display surface side at a low cost.

The color filter layer is not particularly restricted. The color filter layer is not restricted to a red, blue or green layer, and a layer with a color of cyan, magenta, yellow or the like may also be selected as appropriate in accordance with the desired application.

Further, for example, when the electrowetting display comprises a color filter layer and a TFT, the color filter layer may be arranged on the side of the display element on which the TFT is laminated or on the opposite side thereof.

### EXAMPLES

Embodiments of the present invention will now be described more concretely by way of examples thereof. However, the present invention is not restricted thereto by any means. It is noted here that, unless otherwise specified, “part (s)” and “%” are all based on mass.

The weight-average molecular weights (Mw) of the polymers obtained in the below-described Synthesis Examples were measured by GPC under the following conditions.
Measurement method: gel permeation chromatography
Standard substance: polystyrene
Apparatus: manufactured by Tosoh Corporation, trade name: HLC-8020
Column: a column prepared by sequentially connecting Guard Column H_{XL}-H, TSK gel G7000H_{XL}, 2×TSK gel GMH_{XL}, and TSK gel G2000H_{XL}, which are manufactured by Tosoh Corporation
Solvent: tetrahydrofuran
Sample concentration: 0.7% by mass
Injection volume: 70 μL
Flow rate: 1 mL/min

### 1. Synthesis of Polymers

### Synthesis Example 1

### Synthesis of Polymer (A1)

To a reaction vessel, 160 parts of propylene glycol monomethyl ether acetate (PGMEA) was loaded, and the temperature thereof was raised to 80° C. To the resulting reaction vessel, 13 parts of methacrylic acid, 46 parts of benzyl methacrylate, 13 parts of styrene, 16 parts of N-phenylmaleimide, 2 parts of n-butyl methacrylate and 10 parts of 2-hydroxyethyl methacrylate, which were used as monomers, and a solution obtained by mixing 5 parts of azobis-2,4-dimethylvaleronitrile as a polymerization catalyst and 25 parts of PGMEA as a solvent were each added dropwise over a period of 2 hours. Thereafter, the resulting mixed solution was heated at 80° C. for 2 hours and then at 100° C. for 1 hour. The thus heated mixed solution was allowed to cool to 23° C., thereby obtaining a PGMEA solution containing a polymer (A1) at a solid concentration of 35% by mass. The thus obtained polymer (A1) had a Mw of 12,000.

### Synthesis Example 2

### Synthesis of Polymer (A2) (Polyimide)

To a three-necked flask, 390 g of γ-butyrolactone (γ-BL) was added as a polymerization solvent, and 120 g of 2,2′-bis(3-amino-4-hydroxyphenyl) hexafluoropropane was added as a diamine compound to the polymerization solvent. After dissolving the diamine compound to the polymerization solvent, 71 g of 4,4′-oxydiphthalic dianhydride was added thereto as an acid dianhydride. Then, after allowing the resulting mixture to react at 60° C. for 1 hour, 19 g of maleic anhydride was added as an end-capping agent. The resultant was further allowed to react at 60° C. for 1 hour and then at an increased temperature of 180° C. for 4 hours, thereby obtaining about 600 g of γ-BL solution containing a polymer (A2) at a solid concentration of 35% by mass. The thus obtained polymer (A2) had a Mw of 8,000.

### Synthesis Example 3

### Synthesis of Polymer (A3) (Polybenzoxazole Precursor)

To a four-necked separable flask equipped with a thermometer, a stirrer, a material inlet port and a dry nitrogen gas-introducing tube, 443.2 g (0.90 mol) of dicarboxylic acid derivative, which was obtained by allowing 1 mol of diphenyl ether-4,4′-dicarboxylic acid to react with 2 mol of 1-hydroxybenzotriazole, and 366.3 parts (1.00 mol) of hexafluoro-2,2-bis(3-amino-4-hydroxyphenyl)propane were loaded, and 3,000 parts of N-methyl-2-pyrrolidone was added and dissolved thereto. Then, using an oil bath, the resulting mixture was allowed to react at 75° C. for 16 hours. Thereafter, 32.8 parts (0.20 mol) of 5-norbornene-2,3-dicarboxylic acid anhydride dissolved in 100 parts of N-methyl-2-pyrrolidone was added, and the resulting mixture was further stirred for 3 hours and the reaction was terminated. After subjecting the reaction mixture to filtration, the cake was added to a solution of water and isopropanol (water/isopropanol=3/1 (mass ratio)), and the resulting precipitates were recovered by filtration, sufficiently washed with water and then dried under vacuum to obtain a polybenzoxazole precursor (polymer (A3)). By adding γ-BL thereto to a polymer (A3) concentration of 35% by mass, a γ-BL solution of the polymer (A3) was obtained. The thus obtained polymer (A3) had a Mw of 15,000.

### Synthesis Example 4

### Synthesis of Polymer (A4) (Polysiloxane)

To a 500-mL three-necked flask, 63.39 parts (0.55 mol) of methyltrimethoxysilane, 69.41 parts (0.35 mol) of phenyltrimethoxysilane, 24.64 parts (0.1 mol) of 2-(3,4-epoxycyclohexyl)ethyltrimethoxysilane and 150.36 parts of propylene glycol monomethyl ether (PGME) were loaded and, while stirring the loaded materials at room temperature, an aqueous phosphoric acid solution prepared by dissolving 0.338 part of phosphoric acid (0.2% by mass with respect to the loaded monomers) in 55.8 parts of water was added over a period of 10 minutes. After stirring the resulting mixture for 1 hour with the flask being immersed in a 70° C. oil bath, the oil bath was heated to 115° C. over a period of 30 minutes. The inner temperature of the flask reached 100° C. one hour after the start of the heating and, from that point on, the flask was heated with stirring for 2 hours (the inner temperature of the flask was 100 to 110° C.). During the reaction, methanol and water, which were by-products, were distillated in a total of 115 parts. To the resulting PGME solution of polymer (A4), PGME was further added to a polymer (A4) concentration of 35% by mass, thereby obtaining a PGME solution of the polymer (A4). The thus obtained polymer (A4) had a Mw of 5,000.

### 2. Preparation of Photosensitive Compositions for Formation of Partition Wall

Composition 1 in the form of a solution was obtained by mixing 100 parts (in terms of the polymer (A1)) of the polymer (A1) solution obtained in Synthesis Example 1, 70 parts of a cross-linking agent (B), 5 parts of a photoinitiator (C), 5 parts of an adhesive assistant (E) and 1 part of a surfactant (F).

Compositions 2 to 7 were also obtained in the same manner by mixing the respective components in accordance with the formulations shown in Table 1 below. In Compositions 2 to 7 as well, the polymer solution obtained above was used such that each composition contained the polymer in the amount shown in Table 1. The details of each component in Table 1 are as shown in Table 2 below.

TABLE 1

| | | Composition 1 | Composition 2 | Composition 3 | Composition 4 | Composition 5 | Composition 6 | Composition 7 |
|---|---|---|---|---|---|---|---|---|
| Polymer | A1 | 100 | 40 | 210 | 100 | | | |
| | A2 | | | | | 100 | | |
| | A3 | | | | | | 100 | |
| | A4 | | | | | | | 100 |
| Cross-linking | B | 70 | 70 | 70 | 100 | 70 | 70 | 70 |
| agent | | | | | | | | |
| Photoinitiator | C | 5 | 5 | 5 | 5 | 5 | 5 | 5 |
| Organic | D | PGMEA | PGMEA | PGMEA | PGMEA | γ-BL | γ-BL | PGME |
| solvent | | | | | | | | |
| Adhesive | E | 5 | 5 | 5 | 5 | 5 | 5 | 5 |
| assistant | | | | | | | | |
| Surfactant | F | 1 | 1 | 1 | 1 | 1 | 1 | 1 |

TABLE 2

| | |
|---|---|
| B | Dipentaerythritol hexaacrylate |
| C | 1-[9-ethyl-6-(2-methylbenzoyl)-9H-carbazol-3-yl]ethanone |
| | 1-(O-acetyloxime) (trade name “IRGACURE Oxe02”, |
| | manufactured by BASF) |
| D | Organic solvent |
| E | Methacryloxypropyltrimethoxysilane |
| | (trade name “XIAMETER OFS-6030 SILANE”, manufactured by |
| | Dow Corning Toray, Co., Ltd.) |
| F | Fluorine surfactant (trade name “FTX-218”, manufactured by |
| | Neos Co., Ltd.) |

### Example 1

### 3. Preparation of Partition Wall

On a 100 nm-thick ITO layer provided on one side of a glass wafer, Composition 1 shown in Table 1 was coated and heat-treated (prebaked) on a hot plate at 100° C. for 300 seconds to form a coating film of 30 μm in height (length in the direction corresponding to the vertical direction in FIG. 1). Using a stepper (model “NSR-2005i10D”, manufactured by Nikon Corporation), the thus formed coating film was exposed through a patterned mask at an exposure dose of 300 mJ/cm²@365 nm (Exposure 1). The thus exposed coating film was immersed in an aqueous solution containing 0.3% by mass of tetramethylammonium hydroxide (TMAH) for 80 seconds (development process) and subsequently washed with water. Then, by air-blowing the washed film at a wind velocity of 10 m/sec for 20 seconds, moisture and development residues such as TMAH were removed. After subsequently heat-treating (drying) the developed film in an oven at 220° C. for 60 minutes, the surface of the heat-treated film was subjected to an UV-ozone treatment by a low-pressure mercury lamp (exposure dose: 3 J/cm² @254 nm) using a table-top optical surface processor (trade name: PL16-110, manufactured by SEN Lights Co., Ltd.), thereby preparing a partition wall (lattice-patterned coating film) having a line width (length in the direction corresponding to the horizontal direction in FIG. 1) of 10 μm, a lattice spacing of 50 μm and a height (length in the direction corresponding to the vertical direction in FIG. 1) of 20 μm. The plan view of the thus obtained partition wall (lattice-patterned coating film) is shown in FIG. 2. FIG. 2 shows a partition wall 20 formed on an ITO layer and, specifically, a plurality of cells 23 compartmentalized by the partition wall 21 were formed on an ITO layer 22.

It is noted here that, in the embodiments of the present invention, the value of exposure dose (J/cm²@254 nm) is the dose of the irradiated ultraviolet radiation that was converted into the amount of light having a wavelength of 254 nm and the value of exposure dose (mJ/cm²@365 nm) is the dose of the irradiated ultraviolet radiation that was converted into the amount of light having a wavelength of 365 nm.

### 4. Preparation of Display Element

A partition wall having a height (length in the direction corresponding to the vertical direction in FIG. 1) of 20 μm, a line width of 10 μm and a lattice spacing of 50 μm was prepared in the same manner as in the above “3. Preparation of Partition Wall”, except that a 0.7 mm-thick glass plate having a 100 nm-thick ITO layer on one side and a 1 μm-thick hydrophobic film (amorphous fluorine-containing polymer “AF1600”, manufactured by DuPont Co.) thereon was used as a substrate and Composition 1 shown in Table 1 was coated on the hydrophobic film of this substrate. A colored oil (liquid obtained by dissolving 0.1 wt % of Sudan Black B (manufactured by Wako Pure Chemical Industries, Ltd.) in octane) was injected to each compartment (cell) surrounded by the thus formed partition wall, and the resulting partition wall-equipped substrate was placed in water. Then, a glass plate 2 having a 100 nm-thick ITO layer on one side was arranged such that the ITO layer of the glass plate 2 was provided on the side of the partition wall-equipped substrate and in contact with the partition wall. Thereafter, by sealing the contact portion between the partition wall and the ITO layer of the glass plate 2 using a photo-curable epoxy adhesive, a display element having not less than 100 cells in the center of the substrate was prepared.

### Examples 2 to 32 and Comparative Example 1

Each partition wall and display element were prepared in the same manner as in Example 1, except that the type of the photosensitive composition for formation of partition wall, the prebaking time, the prebaking temperature, the exposure dose of Exposure 1, the type of developer, the development time, the air-blowing velocity, and the temperature and time of the drying process were changed as shown in Table 3 or 4.

As the developer, an aqueous solution containing 0.25% Na₂CO₃ and 0.25% NaHCO₃ was used in Example 8; an aqueous solution containing 3% TMAH and 0.1% EMULGEN A-60 (surfactant manufactured by Kao Corporation; hereinafter, also referred to as “A-60”) was used in Example 31; and an aqueous solution containing 3% TMAH, 0.1% A-60 and 1% diacetone alcohol (hereinafter, also referred to as “DAA”) was used in Example 32.

### 5. Evaluations

The partition walls and display elements obtained in Examples and Comparative Example were evaluated by the following methods. The results thereof are shown in Table 3 or 4.

### [Resolution]

For each of the thus obtained partition walls, the cross-sectional shape was observed under an electron microscope (model “S-4200”, manufactured by Hitachi High-Technologies Corporation), and the width of the partition wall in contact with the ITO layer (base width) and the width of the partition wall on the side opposite to the side in contact with the ITO layer (top width) were measured under an SEM (model “S-4200”, manufactured by Hitachi High-Technologies Corporation). The resolution was evaluated as: “excellent” when the difference between the base width and the top width was ±1 μm; “good” when the difference was ±2 μm; “rather good” when the difference was ±3 μm; or “poor” when the difference was greater than ±3 μm.

### [In-plane Variation]

For each of the thus obtained partition walls, the surface was observed under an electron microscope (model “S-4200”, manufactured by Hitachi High-Technologies Corporation), and the width of the partition wall was measured at 10 arbitrary points. The in-plane variation was evaluated as: “excellent” when the difference between the maximum and minimum values of the thus obtained 10 width values of the partition wall was ±0.5 μm; “good” when the difference was ±1 μm; “rather good” when the difference was ±2 μm; or “poor” when the difference was greater than ±2 μm.

### [Water Specks, etc.]

For each of the thus obtained partition walls, the surface was visually checked at 10 arbitrary points under a scanning electron microscope (SU3500, manufactured by Hitachi High-Technologies Corporation).

An evaluation of “none” was given when no development residue or water speck (hereinafter, also referred to as “water specks, etc.”) was observed; an evaluation of “some” was given when 1 to 3 water specks, etc. were observed (at 1 to 3 spots); and an evaluation of “present” was given when more than 3 water specks, etc. were observed (at more than 3 spots).

### [Evaluation of Operational State of Display Element]

For each of the display elements obtained in Examples and Comparative Example, a direct-current voltage of 10 V/10 μm intervals was applied between the pair of ITO layers sandwiching the partition wall, colored oil and water. In 100 cells that were formed on the substrate center of each display element obtained in Examples, the application of the voltage caused contraction of the colored oil (change into a hemispherical shape), making the backside transparent and, when the application of the voltage was terminated, color display was restored in all of the cells.

Taking application of the above-described direct-current voltage and termination of the application as 1 cycle, the cycle was repeated 100 times. The time point at which the voltage application was terminated after the 100 cycles was defined as “0 second”, and the operational state of each display element was evaluated based on the time between the termination of the voltage application and the restoration of color display (shutter speed or response speed). Specifically, the operational state of each display element was evaluated as: “excellent” when the time required for restoration of color display was less than 20 milliseconds; “good” when the time was 20 milliseconds to less than 50 milliseconds; “rather good” when the time was 50 milliseconds to less than 100 milliseconds; or “poor” when the time was 100 milliseconds or longer.

TABLE 3

| | | | Example 1 | Example 2 | Example 3 | Example 4 | Example 5 |
|---|---|---|---|---|---|---|---|
| Photosensitive Composition for | | | Composition 1 | Composition 1 | Composition 1 | Composition 1 | Composition 1 |
| Formation of Partition Wall | | | | | | | |
| Prebaking | Temperature | ° C. | 100 | 100 | 100 | 100 | 100 |
| | Time | sec | 300 | 300 | 300 | 300 | 300 |
| Exposure | Exposure dose | mJ/cm² | 300 | 300 | 300 | 300 | 300 |
| Development | Developer | | 0.3% TMAH | 3% TMAH | 5% TMAH | 10% TMAH | 0.05% KOH |
| | Time | sec | 120 | 80 | 60 | 60 | 80 |
| Drying | Temperature | ° C. | 220 | 220 | 220 | 220 | 220 |
| | Time | min | 60 | 60 | 60 | 60 | 60 |
| Air-blowing | Velocity | m/sec | 10 | 10 | 10 | 10 | 10 |
| Patterning | Resolution | | excellent | excellent | excellent | excellent | rather good |
| properties | In-plane variation | | excellent | excellent | excellent | excellent | rather good |
| | Water specks, etc. | | none | none | none | none | none |
| Element properties | Operational state | Reliability | excellent | excellent | excellent | excellent | rather good |

| | | | Example 6 | Example 7 | Example 8 | Example 9 | Example 10 |
|---|---|---|---|---|---|---|---|
| Photosensitive Composition for | | | Composition 1 | Composition 1 | Composition 1 | Composition 2 | Composition 3 |
| Formation of Partition Wall | | | | | | | |
| Prebaking | Temperature | ° C. | 100 | 100 | 100 | 100 | 100 |
| | Time | sec | 300 | 300 | 300 | 300 | 300 |
| Exposure | Exposure dose | mJ/cm² | 300 | 300 | 300 | 300 | 300 |
| Development | Developer | | 0.5% Na₂CO₃ | 0.5% NaHCO₃ | 0.25% Na₂CO₃ | 3% TMAH | 3% TMAH |
| | | | | | 0.25% NaHCO₃ | | |
| | Time | sec | 80 | 80 | 80 | 80 | 80 |
| Drying | Temperature | ° C. | 220 | 220 | 220 | 220 | 220 |
| | Time | min | 60 | 60 | 60 | 60 | 60 |
| Air-blowing | Velocity | m/sec | 10 | 10 | 10 | 10 | 10 |
| Patterning | Resolution | | rather good | rather good | rather good | good | good |
| properties | In-plane variation | | rather good | rather good | rather good | good | good |
| | Water specks, etc. | | none | none | none | none | none |
| Element properties | Operational state | Reliability | rather good | rather good | rather good | good | good |

| | | | Example 11 | Example 12 | Example 13 | Example 14 |
|---|---|---|---|---|---|---|
| Photosensitive Composition for | | | Composition 4 | Composition 5 | Composition 6 | Composition 7 |
| Formation of Partition Wall | | | | | | |
| Prebaking | Temperature | ° C. | 100 | 100 | 100 | 100 |
| | Time | sec | 300 | 300 | 300 | 300 |
| Exposure | Exposure dose | mJ/cm² | 300 | 300 | 300 | 300 |
| Development | Developer | | 3% TMAH | 3% TMAH | 3% TMAH | 3% TMAH |
| | Time | sec | 80 | 80 | 80 | 80 |
| Drying | Temperature | ° C. | 220 | 220 | 220 | 220 |
| | Time | min | 60 | 60 | 60 | 60 |
| Air-blowing | Velocity | m/sec | 10 | 10 | 10 | 10 |
| Patteming | Resolution | | excellent | excellent | excellent | excellent |
| properties | In-plane variation | | excellent | excellent | excellent | excellent |
| | Water specks, etc. | | none | none | none | none |
| Element properties | Operational state | Reliability | excellent | excellent | excellent | excellent |

TABLE 4

| | | | Example 15 | Example 16 | Example 17 | Example 18 | Example 19 |
|---|---|---|---|---|---|---|---|
| Photosensitive Composition for Formation of | | | Composition 1 | Composition 1 | Composition 1 | Composition 1 | Composition 1 |
| Partition Wall | | | | | | | |
| Prebaking | Temperature | ° C. | 100 | 100 | 100 | 100 | 100 |
| | Time | sec | 300 | 300 | 300 | 300 | 300 |
| Exposure | Exposure dose | mJ/cm² | 300 | 300 | 300 | 300 | 300 |
| Development | Developer | | 3% TMAH | 3% TMAH | 3% TMAH | 3% TMAH | 3% TMAH |
| | Time | sec | 40 | 180 | 80 | 80 | 80 |
| Drying | Temperature | ° C. | 220 | 220 | 180 | 270 | 220 |
| | Time | min | 60 | 60 | 60 | 60 | 20 |
| Air-blowing | Velocity | m/sec | 10 | 10 | 10 | 10 | 10 |
| Patterning | Resolution | | good | good | good | good | good |
| properties | In-plane variation | | good | good | good | good | good |
| | Water specks, etc. | | none | none | none | none | none |
| Element properties | Operational state | Reliability | good | good | good | good | good |
| | | | Example 20 | Example 21 | Example 22 | Example 23 | Example 24 |
| Photosensitive Composition for Formation of | | | Composition 1 | Composition 1 | Composition 1 | Composition 1 | Composition 1 |
| Partition Wall | | | | | | | |
| Prebaking | Temperature | ° C. | 100 | 80 | 150 | 100 | 100 |
| | Time | sec | 300 | 300 | 300 | 90 | 500 |
| Exposure | Exposure dose | mJ/cm² | 300 | 300 | 300 | 300 | 300 |
| Development | Developer | | 3% TMAH | 3% TMAH | 3% TMAH | 3% TMAH | 3% TMAH |
| | Time | sec | 80 | 80 | 80 | 80 | 80 |
| Drying | Temperature | ° C. | 220 | 220 | 220 | 220 | 220 |
| | Time | min | 150 | 60 | 60 | 60 | 60 |
| Air-blowing | Velocity | m/sec | 10 | 10 | 10 | 10 | 10 |
| Patterning | Resolution | | good | rather good | rather good | rather good | rather good |
| properties | In-plane variation | | good | rather good | rather good | rather good | rather good |
| | Water specks, etc. | | none | none | none | none | none |
| Element properties | Operational state | Reliability | good | good | good | good | good |
| | | | Example 25 | Example 26 | Example 27 | Example 28 | Example 29 |
| Photosensitive Composition for Formation of | | | Composition 1 | Composition 1 | Composition 1 | Composition 1 | Composition 1 |
| Partition Wall | | | | | | | |
| Prebaking | Temperature | ° C. | 100 | 100 | 100 | 100 | 100 |
| | Time | sec | 300 | 300 | 300 | 300 | 300 |
| Exposure | Exposure dose | mJ/cm² | 40 | 800 | 300 | 300 | 300 |
| Development | Developer | | 3% TMAH | 3% TMAH | 3% TMAH | 3% TMAH | 3% TMAH |
| | Time | sec | 80 | 80 | 80 | 80 | 80 |
| Drying | Temperature | ° C. | 220 | 220 | 220 | 220 | 220 |
| | Time | min | 60 | 60 | 60 | 60 | 60 |
| Air-blowing | Velocity | m/sec | 10 | 10 | 1 | 5 | 50 |
| Patterning | Resolution | | rather good | rather good | good | excellent | excellent |
| properties | In-plane variation | | rather good | rather good | good | excellent | excellent |
| | Water specks, etc. | | none | none | some | none | none |
| Element properties | Operational state | Reliability | good | good | good | excellent | excellent |

| | | | | | | Comparative |
|---|---|---|---|---|---|---|
| | | | Example 30 | Example 31 | Example 32 | Example 1 |
| Photosensitive Composition for Formation of | | | Composition 1 | Composition 1 | Composition 1 | Composition 1 |
| Partition Wall | | | | | | |
| Prebaking | Temperature | ° C. | 100 | 100 | 100 | 100 |
| | Time | sec | 300 | 300 | 300 | 300 |
| Exposure | Exposure dose | mJ/cm² | 300 | 300 | 300 | 300 |
| Development | Developer | | 3% TMAH | 3% TMAH | 3% TMAH | 3% TMAH |
| | | | | | 0.1% A-60 | 0.1% A-60 |
| | | | | | | 1% DAA |
| | Time | sec | 80 | 80 | 80 | 80 |
| Drying | Temperature | ° C. | 220 | 220 | 220 | 220 |
| | Time | min | 60 | 60 | 60 | 60 |
| Air-blowing | Velocity | m/sec | 100 | 10 | 10 | 0 |
| Patterning | Resolution | | excellent | excellent | excellent | poor |
| properties | In-plane variation | | excellent | excellent | excellent | poor |
| | Water specks, etc. | | none | none | none | present |
| Element properties | Operational state | Reliability | excellent | excellent | excellent | poor |

### 6. Evaluation Results

The partition walls obtained in Examples 1 to 32 are believed to have excellent patterning properties. Furthermore, the display elements obtained in Examples 1 to 32 were confirmed to have a sufficiently quick shutter speed even after the above-described cycle was repeated 100 times. Particularly, in the display elements obtained in Examples 1 to 4, 11 to 14 and 28 to 32, even after the above-described cycle was repeated 100 times, the display state changed in a considerably short time of less than 20 milliseconds. That is, it was found that the display elements obtained in Examples are capable of changing the state of the colored oil (non-polar liquid) in a smooth and stable manner over a prolonged period of time.

Meanwhile, in the evaluation of the operational state of the display element obtained in Comparative Example 1, abnormality was observed in the change (contraction behavior) of the colored oil into a substantially hemispherical shape when the application of voltage was terminated, and a period of not less than 100 milliseconds was required for the display state to be changed.

Obviously, numerous modifications and variations of the present invention are possible in light of the above teachings. It is therefore to be understood that within the scope of the appended claims, the invention may be practiced otherwise than as specifically described herein.

1. A method of producing a partition wall, said method comprising the following steps (a) to (d):
(a) forming a film using a photosensitive composition;
(b) exposing the thus formed film;
(c) developing the thus exposed film with an aqueous alkaline solution; and
(d) applying wind to the thus developed film,
wherein said partition wall compartmentalizes a housing space which is formed between first and second electrode layer stacks and which contains a polar liquid and a non-polar liquid that are immiscible with each other.

2. The method according to claim 1, wherein said step (d) is a wind-blowing step.

3. The method according to claim 1, further comprising (e) heating said film after said step (d).

4. The method according to claim 2, wherein, in said step (d), said wind-blowing is performed at a wind velocity of 1 to 200 m/sec.

5. The method according to claim 2, wherein, in said step (d), said wind-blowing is performed at a wind velocity of 1 to 100 m/sec.

6. The method according to claim 1, wherein said aqueous alkaline solution comprises a basic compound.

7. The method according to claim 1, wherein said aqueous alkaline solution comprises at least one compound selected from the group consisting of a nitrogen atom-containing compound, a sodium atom-containing compound and a potassium atom-containing compound.

8. The method according to claim 1, wherein said aqueous alkaline solution comprises at least one compound selected from the group consisting of tetramethylammonium hydroxide, tetraethylammonium hydroxide, tetrapropylammonium hydroxide, tetrabutylammonium hydroxide, tetrahexylammonium hydroxide, trimethyl(2-hydroxyethyl)ammonium hydroxide, trimethylmonoethanolammonium hydroxide, sodium hydroxide, sodium carbonate, sodium bicarbonate, potassium hydroxide, potassium carbonate and potassium bicarbonate.

9. The method according to claim 6, wherein a concentration of said basic compound in said aqueous alkaline solution is from 0.01 to 10% by mass.

10. The method according to claim 6, wherein a concentration of said basic compound in said aqueous alkaline solution is from 0.01 to 5% by mass.

11. The method according to claim 1, wherein said aqueous alkaline solution comprises a surfactant.

12. The method according to claim 1, wherein said aqueous alkaline solution comprises an organic solvent.

13. The method according to claim 1, wherein said photosensitive composition comprises an alkali-soluble polymer and a photoinitiator.

14. The method according to claim 1, wherein said photosensitive composition comprises a cross-linking agent.

15. The method according to claim 13, wherein a content of said alkali-soluble polymer is 20 to 80% by mass with respect to a total solid content in said photosensitive composition.

16. The method according to claim 13, wherein said alkali-soluble polymer is a compound having at least one functional group selected from the group consisting of a carboxyl group, a phenolic hydroxyl group and a silanol group.

17. The method according to claim 13, wherein said alkali-soluble polymer is at least one polymer selected from the group consisting of an acrylic resin, a polyimide, a polybenzoxazole, a polysiloxane, a polyolefin, a cardo skeleton-containing resin and a novolac resin.

18. The method according to claim 14, wherein a content of said cross-linking agent is 10 to 70% by mass with respect to a total solid content in said photosensitive composition.

19. The method according to claim 13, wherein a content of said photoinitiator is 0.1 to 20% by mass with respect to a total solid content in said photosensitive composition.

20. A method of producing a display element comprising using a partition wall obtained by the method according to claim 1.

21. A method of producing an electrowetting display comprising using a display element obtained by the method according to claim 20.

22. The method according to claim 21, wherein said electrowetting display comprises a color filter layer.
